(19) United States
(12) Patent Application Publication
(10) Pub. No.: US 2011/0201219 A1
(43) Pub. Date: Aug. 18, 2011

(54) METHOD AND ISOLATING STRIP FOR THE ALTERNATIVE CONNECTION OF AN OUTPUT LINE, CONNECTED TO A FIRST INPUT LINE, TO A SECOND INPUT LINE

(75) Inventors: Klaus Koch, Schlegel (DE); Detlev Struck, Berlin (DE)

(73) Assignee: ADC GmbH, Berlin (DE)

(21) Appl. No.: 13/025,303

(22) Filed: Feb. 11, 2011

(30) Foreign Application Priority Data
Feb. 12, 2010 (DE) 10 2010 007 856.5

(51) Int. Cl. H01R 13/44; B23P 17/04

(52) U.S. Cl. 439/131; 29/525.01

(57) ABSTRACT

The invention relates to a method for the alternative connection of an output line (51), connected to a first input line (50), to a second input line (52) by means of at least one isolating strip (10), wherein the isolating strip (10) comprises first contact elements (20) with a first core connection contact (21) and a first contact limb (22) and comprises second contact elements (30) with a second core connection contact (31) and a second contact limb (32), wherein a first and a second contact limb (22, 32) respectively form an isolating contact (40), wherein said first core connection contacts (21) have the first input lines (50) connected to them and said second core connection contacts (31) have the output lines (51) connected to them, wherein an isolating connector (70, 70a) is used to open the isolating contact (40) and hence to break the connection between the first input line (50) and the output line (51), said second input line (52) being connected to the output line (51) via the isolating connector (70, 70a) and the second contact limb (32) or via a third core connection contact (33) on the second contact element (30), and an isolating strip (10).

This application claims benefit of Serial No. 10 2010 007 856.5, filed 12 Feb. 2010 in Germany and which application is incorporated herein by reference. To the extent appropriate, a claim of priority is made to the above disclosed application.

### BACKGROUND

The invention relates to a method and an isolating strip for the alternative connection of an output line, connected to a first input line, to a second input line.

If a subscriber wishes to change his provider, for example in order to use XDSL services, then the problem arises that it is necessary to perform rejumpering. This used first of all to be done in the region of the main distributor, where the rejumpering was done in what are known as collocation distributors. In future, the rejumpering will be done in the region of the cable distributors. For this purpose, the network operator continues to route a main cable from the main distributor to the cable splitter, where these are connected in the form of twin cores. On the route from the main distributor to the cable splitter, the twin cores are terminated at two separate terminations (incoming and outgoing) in a collocation distributor which needs to be set up afresh. In normal operation, both terminations are jumpered through on a 1-to-1 basis.

An alternative service provider can then set up a further cable splitter/multifunctional housing in addition to the collocation distributor of the network operator. Twin cores are laid down on terminations between both distributors. If a subscriber then wishes to change from the network operator to the alternative service provider, a twin core for the alternative service provider is jumpered from the latter's termination in the collocation distributor to the termination (outgoing) of the network operator. Said jumpering requires the connection for the terminations (incoming and outgoing) of the network operator to be lifted and the old jumper wire needs to be removed. This represents not inconsiderable jumpering complexity, wherein additionally the collocation distributor “grows” with cores as a result of incomplete removal of the original jumper wires.

### SUMMARY

The invention is based on the technical problem of providing a method and an isolating strip for the alternative connection of an output line, connected to a first input line, to a second input line which is used to reduce the necessary jumpering complexity.

The method for the alternative connection of at least one output line, connected to a first input line, to a second input line by means of at least one isolating strip, wherein the isolating strip comprises first contact elements with a first core connection contact and a first contact limb and comprises second contact elements with a second core connection contact and a second contact limb, wherein a first and a second contact limb respectively form an isolating contact, said first core connection contacts having the first input lines connected to them and said second core connection contacts having the output lines connected to them, comprises the following method steps: an isolating connector is used to open the isolating contact and hence to break the connection between the first input line and the output line, wherein the second input line is connected to the output line via the isolating connector and the second contact limb or via a third core connection contact on the second contact element. This means that the jumpering operation can take place in a distributor and the separate collocation distributor can be dispensed with. As a result, the necessary jumpering operations between the distributors are also dispensed with.

In one alternative, the second input line is connected by the isolating connector. In this case, the isolating connector is arranged at the end of the input line, for example, wherein preferably an isolating connector connects a respective twin core, i.e. the isolating connector opens two isolating contacts at the same time. To this end, the isolating connector has contact areas to which the second input lines are connected, wherein the contact areas set up an electrical connection to the second contact limbs when plugged into the isolating contact(s). Alternatively, the top of the isolating connector may be designed to have core connection contacts which are then electrically connected to the contact areas, wherein the second input lines are connected to the core connection contacts.

In the second alternative, the second contact element is designed to have a third core connection contact which is electrically connected to the second core connection contact. In this case, the isolating connector breaks the original connection only, whereas the new connection is made by connecting the second input line to the third core connection contact.

In one preferred embodiment, connection of the second input line pushes the isolating connector into the isolating contact. This ensures that the first connection is always broken before the second input line is connected. This prevents two different service providers from being connected to the same output line simultaneously.

In a further preferred embodiment, the isolating connector is locked in the plugged-in state. This prevents the isolating connector from being able to be pulled inadvertently. Preferably, the locking is in a form such that pulling the isolating connector presupposes or prompts removal of the second input line.

The isolating strip according to the invention comprises first contact elements with a first core connection contact and a first contact limb, respectively, and second contact elements with a second core connection contact and a second contact limb, respectively, wherein a first and a second contact limb respectively form an isolating contact, said second contact elements respectively comprising a third core connection contact which is electrically connected to the second core connection contact.

Preferably, the isolating strip is designed to have latching means which use latching means on an isolating connector to lock said isolating connector in the isolating contact in the plugged-in state. This prevents inadvertent pulling of the isolating connector.

As a further preference, the isolating connector or the isolating connectors is/are integral parts of the isolating strip. As a result, the isolating connector is arranged captively and it is possible to implement an extremely flat design with plugged-in isolating connectors.

In a further preferred embodiment, the isolating connectors are positioned relative to the third core connection contacts such that the isolating connectors are automatically plugged in when the third core connection contacts are connected up.

As an alternative to the third core connection contact on the second contact element, it is also possible to use an isolating connector, comprising an insulating body, wherein the top of the isolating connector has core connection contacts arranged on it, the insulating body having contact areas arranged on it which are electrically connected to the core connection contacts.

### BRIEF DESCRIPTION OF THE DRAWINGS

The invention is explained in more detail below with reference to a preferred exemplary embodiment. In the figures:

FIG. 1 shows a schematic block diagram of an alternative connection using a collocation distributor (prior art),

FIG. 2 shows a schematic cross-sectional illustration through an isolating strip with a third core connection contact,

FIG. 3 shows a schematic cross-sectional illustration through an isolating strip with a third core connection contact and an integrated isolating connector and a third core connection contact which is not connected up,

FIG. 4 shows a schematic cross-sectional illustration through an isolating strip with a third core connection contact and an integrated isolating connector and a third core connection contact which is connected up,

FIG. 5 shows a schematic cross-sectional illustration through an isolating strip with the second input line removed, and

FIG. 6 shows a schematic illustration of an isolating connector with core connection contacts on the top, and

FIG. 7 shows a schematic cross-sectional illustration through an isolating strip with an isolating connector as shown in FIG. 6.

### DETAILED DESCRIPTION

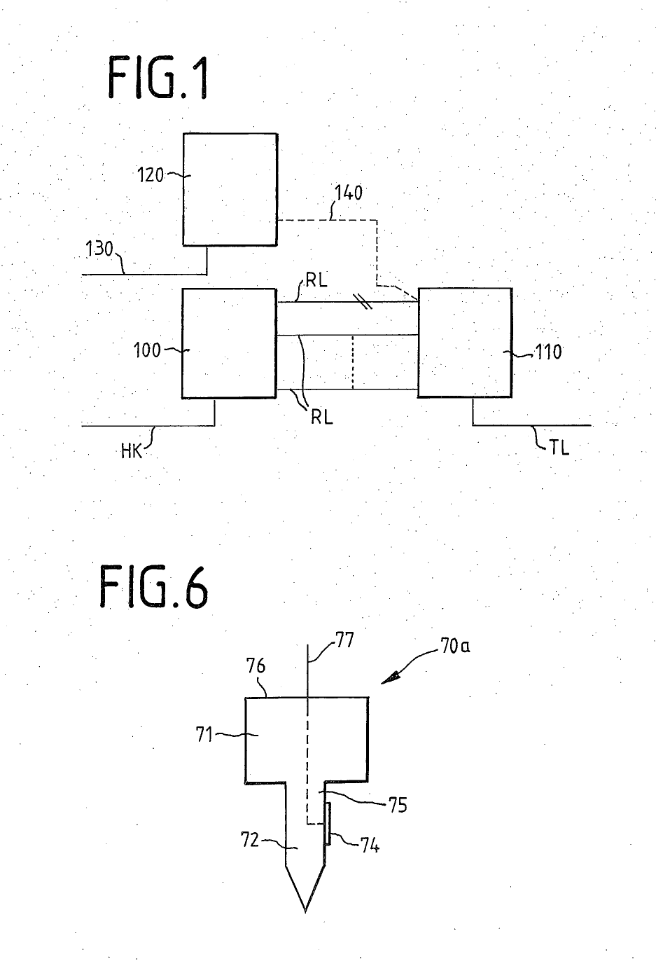

FIG. 1 shows a schematic block diagram of an alternative connection for input lines to output lines. In this arrangement, a main distributor—not shown—terminates the incoming twin cores of a main cable HK in a cable splitter 100. The twin cores of the main cable HK are then jumpered to a collocation distributor 110 by means of jumper lines RL and from there are routed onward via subscriber lines TL. Arranged in parallel with the cable splitter 100 is a further distributor 120 from a further service provider, which is connected to a DSLAM—not shown—via lines 130, for example. If a subscriber now wishes to change his service provider, the jumper line RL associated with the subscriber is removed and an XDSL line 140 is pulled from the distributor 120 to the collocation distributor 110, for example, instead. The newly pulled XDSL line 140 is shown by way of example in dashes in FIG. 1, the removal of the original jumper line RL being symbolized by oblique strokes.

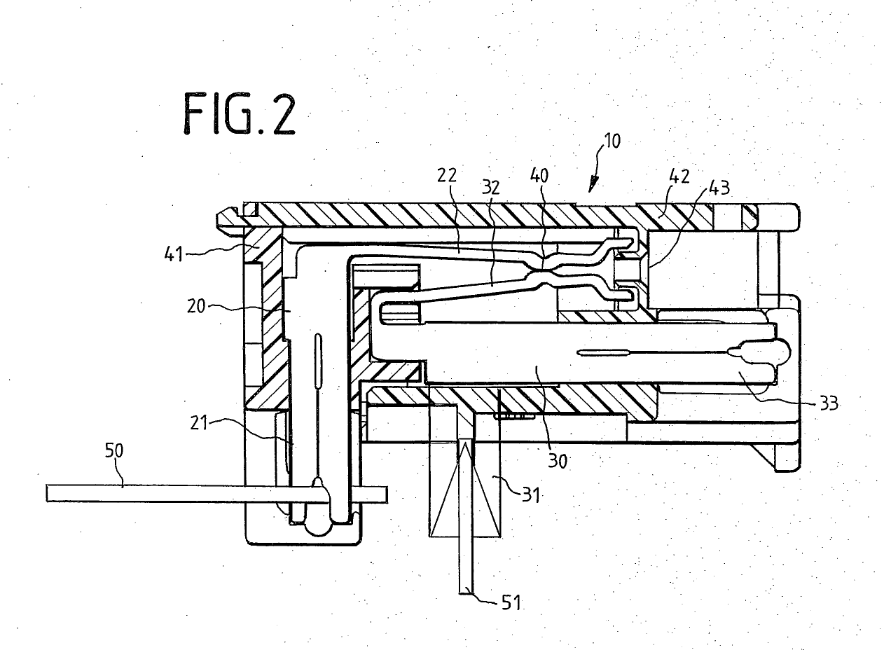

FIG. 2 shows a cross section through an isolating strip 10. The isolating strip 10 comprises a first contact element 20. The first contact element 20 comprises a first core connection contact 21 and a first contact limb 22, said first contact element 20 being of integral or single-part design. Furthermore, the isolating strip 10 comprises a second contact element 30. The second contact element 30 comprises a second core connection contact 31, a second contact limb 32 and a third core connection contact 33. In this case, the first contact limb 22 and the second contact limb 32 form an isolating contact 40. The isolating contact 40 connects the two contact limbs 22, 32 electrically without an isolating connector. In the example shown, the core connection contacts 21, 31, 33 are in the form of insulation displacement contacts. In principle, however, other types of contacts such as wire-wrap are also possible. The isolating strip 10 usually comprises a multiplicity of first and second contact elements in order to connect an appropriate number of twin cores. In the example shown, the first core connection contacts 21 are arranged so as to be rotated through 90° with respect to the third core connection contacts 33. However, it is also possible for the first and third core connection contacts 21, 33 to be arranged in parallel rows. The first and second contact elements 20, 30 are arranged in a housing, preferably comprising plastic. In this case, the housing comprises a housing lower part 41 and a housing top part 42. The housing top part 42 has openings 43 in the region of the isolating contacts 40, into which openings it is possible to plug in an isolating connector, which will be explained in more detail later. In this context, the isolating connectors are usually in a form such that an isolating connector serves two isolating contacts 40 at the same time.

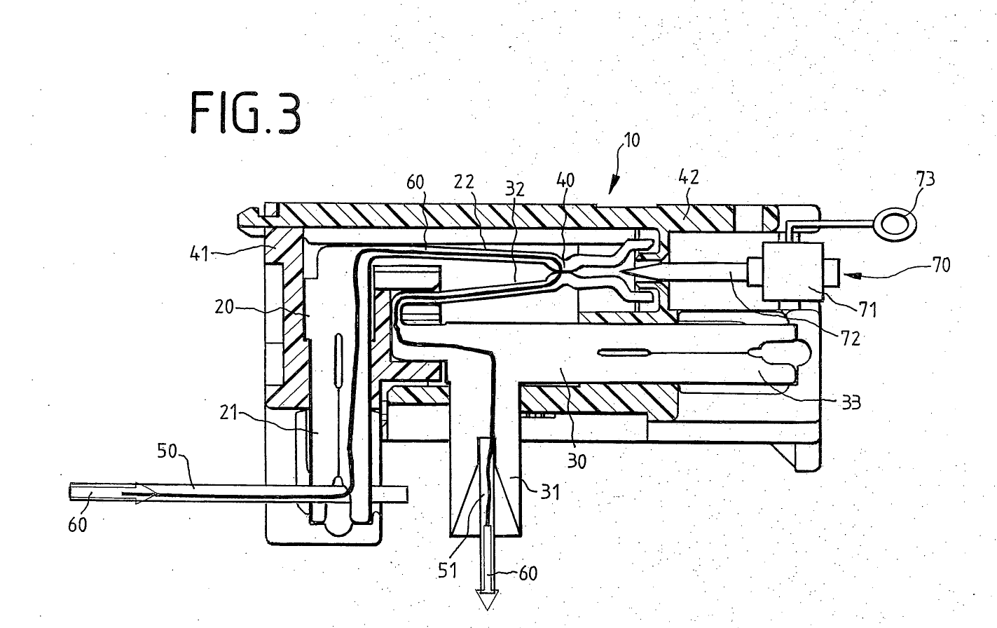

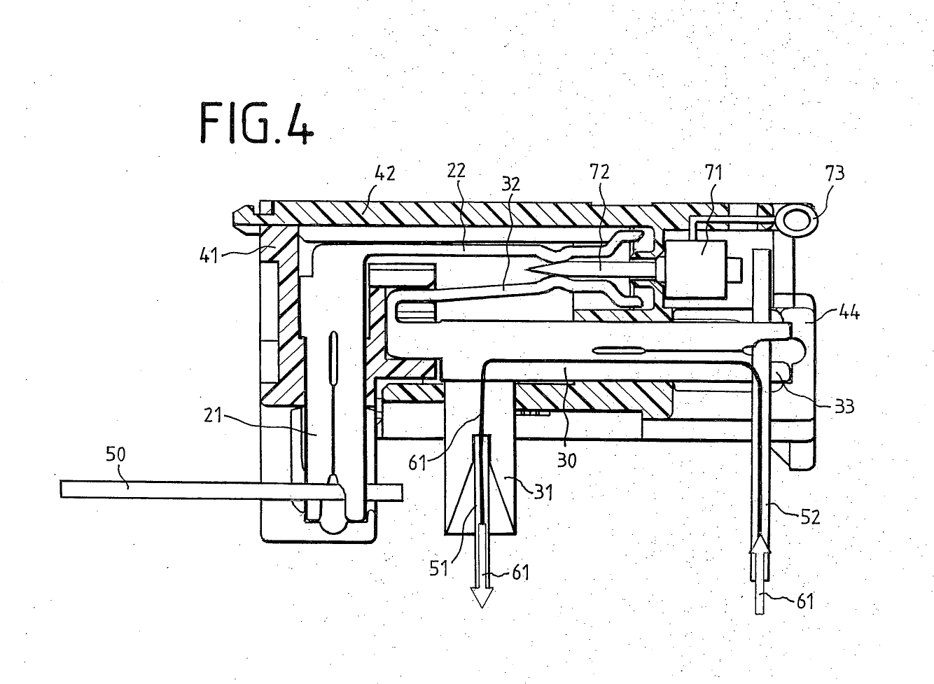

The first core connection contacts 21 then have the first input lines 50 connected to them. Transferred to the illustration shown in FIG. 1, the first input lines 50 are the twin cores of the main cable HK. The second core connection contacts 31 have the output lines 51 connected to them. Transferred to the illustration shown in FIG. 1, the output lines 51 are the subscriber lines TL to the subscribers. This results in the first signal path 60 shown in FIG. 3, i.e. a first input line 50 is electrically connected to an output line 51 via the first core connection contact 21, the first contact limb 22, the isolating contact 40, the second contact limb 32 and the second core connection contact 31. In addition, FIG. 3 shows an isolating connector 70. The isolating connector 70 is an integral part of the isolating strip 10. The isolating connector comprises a housing 71, from which an insulating body 72 projects. The housing 71 also has a pulling hook 73 arranged on it.

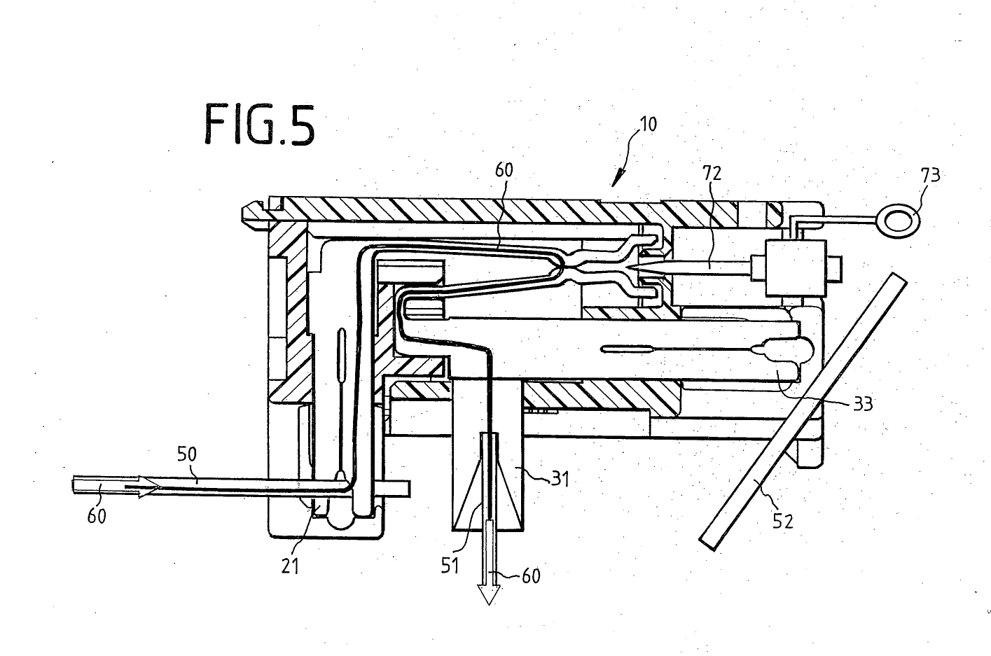

If, instead of the first input line 50, a second input line 52 is now intended to be connected to the output line 51, said second input line 52 is connected to the third core connection contact 33, which is shown in FIG. 5. When the second input line 52 is pushed into the third core connection contact 33, in the form of an insulation displacement contact, the second input line 52 and/or a connection tool pushes the isolating connector 70 into the isolating contact 40, the latter being opened by the insulating body 72. The opening of the isolating contact 40 interrupts the first signal path 60. The third core connection contact 33 and the second core connection contact 31 are then used to produce a second signal path 61 from the second input line 52 to the output line 51. In this case, the first signal path 60 is first of all interrupted before the second signal path 61 is produced. This ensures that two input lines are not simultaneously connected to one output line. In the plugged-in state, the pulling hook 73 terminates almost at the top 44 of the housing upper part 42, which means that a very compact design can be implemented.

If the connection to the first input line 50 is now intended to be made again, it is first of all necessary to remove the second input line 52 from the third core connection contact 33 so that the isolating connector 70 can be pulled, preferably by means of a pulling hook 73. This likewise again ensures that two different input lines 50, 52 are not simultaneously connected to the output line 51. When the insulating connector 70 has been pulled, the first signal path 60 is then available again, which is shown in FIG. 5.

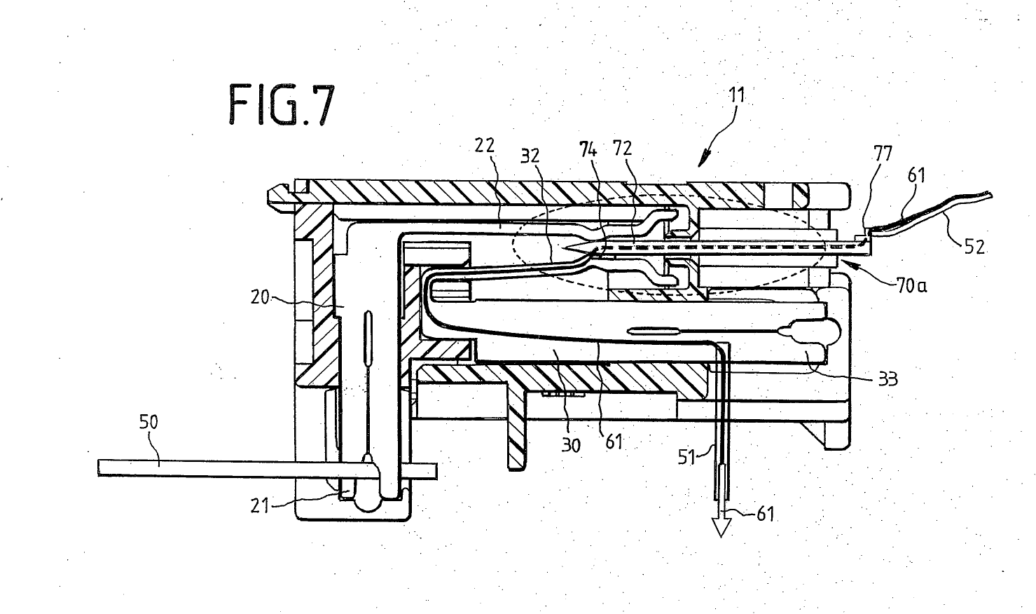

FIG. 6 shows an isolating connector 70a in an alternative embodiment. The isolating connector 70a requires an isolating strip 11 (see FIG. 7), wherein the third core connection contact can be dispensed with. The isolating connector 70a is always used to connect the a and b wires of a twin core simultaneously. The isolating connector 70a again comprises a housing 71 and an insulating body 72. In addition, the isolating connector 70a has two contact areas 74 which are arranged on one side 75 of the insulating body 72. In this case, the front contact area 74 conceals the contact area arranged behind it. The top 76 of the housing 71 has two core connection contacts 77 arranged on it which are preferably in the form of insulation displacement contacts, the rear core connection contact 77 being concealed. In this case, a respective core connection contact 77 is electrically connected to a contact area 74, which is symbolized by the dashed line. If a second input line 52 now needs to be connected to the output line 51, there are two options, in principle:
the second input line 52 is connected to the associated core connection contact 77 and then the isolating connector 70a is plugged into the isolating contact 40, or
the isolating connector 70a is plugged into the isolating contact 40 or is in a position shortly before the plugged-in state, with the input line(s) 52 subsequently being connected to the core connection contact(s) 77, wherein the isolating connector 70a is plugged into the isolating contact 40 no later than by the connection operation. The contact area 74 then electrically connects the core connection contact 77 to the second contact limb 32 and hence to the second core connection contact 31. This means that the second signal path 61 is produced, wherein the first signal path 60 is interrupted, since the isolating contact is open and the insulating body 72 does not transmit any signals from the first contact limb 22.

### LIST OF REFERENCE SYMBOLS

10 Isolating strip (3 core connection contacts)
11 Isolating strip (2 core connection contacts)
20 First contact element
21 First core connection contact
22 First contact limb
30 Second contact element
31 Second core connection contact
32 Second contact limb
33 Second core connection contact
40 Isolating contact
41 Housing lower part
42 Housing upper part
43 Openings
44 Top of the housing upper part
50 First input line
51 Output line
52 Second input line
60 First signal path
61 Second signal path
70 Isolating connector
70a Isolating connector
71 Housing
72 Insulating body
73 Pulling hook
74 Contact area
75 Side of the insulating body
76 Top of the housing
77 Core connection contact
100 Cable splitter
110 Collocation distributor
120 Further distributor
130 Lines
140 XDSL line
HK Main cable
RL Jumper lines
TL Subscriber lines

1. A method for the alternative connection of an output line, connected to a first input line, to a second input line by means of at least one isolating strip, wherein the isolating strip comprises first contact elements with a first core connection contact and a first contact limb and comprises second contact elements with a second core connection contact and a second contact limb, wherein a first and a second contact limb respectively form an isolating contact, said first core connection contacts having the first input lines connected to them and said second core connection contacts having the output lines connected to them,
wherein
an isolating connector is used to open the isolating contact and hence to break the connection between the first input line and the output line, wherein the second input line is connected to the output line via the isolating connector and the second contact limb or via a third core connection contact on the second contact element.

2. The method as claimed in claim 1, wherein connection of the second input line pushes the isolating connector into the isolating contact.

3. The method as claimed in claim 1, wherein the isolating connector is locked in the plugged-in state.

4. An isolating strip, comprising first contact elements with a first core connection contact and a first contact limb, respectively, and second contact elements with a second core connection contact and a second contact limb, respectively, wherein a first and a second contact limb respectively form an isolating contact,
wherein
the second contact elements respectively comprise a third core connection contact which is electrically connected to the second core connection contact.

5. The isolating strip as claimed in claim 4, wherein the isolating strip is designed with latching means which use latching means on an isolating connector to lock said isolating connector in the plugged-in state.

6. The isolating strip as claimed in claim 4, wherein the isolating connectors are integral parts of the isolating strip.

7. The isolating strip as claimed in claim 6, wherein the isolating connectors are positioned relative to the third core connection contacts such that the isolating connectors are automatically plugged in when the third core connection contacts are connected up.

8. An isolating connector, comprising an insulating body for plugging into an isolating contact,
wherein
the top of the isolating connector has core connection contacts arranged on it, the insulating body having contact areas arranged on it which are electrically connected to the core connection contacts.
